(19) United States
(12) Patent Application Publication
(10) Pub. No.: US 2016/0245487 A1
(43) Pub. Date: Aug. 25, 2016

(54) NIGHT LAMP

(71) Applicant: Hua-Cheng Pan, Tainan (TW)

(72) Inventor: Chih-Liang Wang, Tainan (TW)

(21) Appl. No.: 14/630,663

(22) Filed: Feb. 25, 2015

(51) Int. Cl. F21V 17/02; F21V 23/00; F21S 8/00; F21V 23/04

(52) U.S. Cl. CPC F21V 17/02; F21V 23/04; F21V 23/003; F21S 8/035; F21Y 2101/02

(57) ABSTRACT

The night lamp contains a lamp base, at least a lighting element, a main shade member, and at least an auxiliary shade member. The lighting element is electrically connected to the lamp base. The main shade member is configured to a side of the lamp base. The auxiliary shade member is joined to the main shade member by attaching their traversal faces so that light beams from the lighting element is able to enter the inside of the main and auxiliary shade members.

### BACKGROUND OF THE INVENTION

(a) Technical Field of the Invention

The present invention is generally related to night lamps, and more particular to a night lamp assembled similar to building blocks.

(b) Description of the Prior Art

Night lamps prevent people from bumping into things during the night or in the house when and where illumination is insufficient. In addition, night lamps can also help creating a soothing ambience. Therefore manufacturers have provided night lamps of various designs so as to attract customers.

However conventional night lamps are usually injection-molded and have fixed appearances. How to enhance their flexibility so as to improve their taste and value becomes an importance issue.

### SUMMARY OF THE INVENTION

A major objective of the present invention is to provide a novel night lamp that can be assembled into different shapes and appearances so as to enhance the night lamp's competitiveness.

The night lamp contains the following components.

A lamp base has a control circuit inside and prongs for connecting to a power source provided from a lateral side.

At least a lighting element is electrically connected to the control circuit.

A main shade member is configured to a side of the lamp base and contains at least a first light traversal face allowing light beams from the lighting element to pass through.

At least an auxiliary shade member contains at least a second light traversal face. The auxiliary shade member is joined to the main shade member by attaching the second light traversal face to the first light traversal face so that light beams from the lighting element is able to enter the inside of the auxiliary shade member.

The present invention allows a user to assemble the auxiliary shade member to the main shade member according to the user's preference. As the first and second light traversal faces are pervious to light, light beams from the lighting element can penetrate to the auxiliary shade member, making both the main and auxiliary shade members to produce various illuminating effect.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a night lamp according to a first embodiment of the present invention.

FIG. 2 is a perspective break-down diagram showing the night lamp of FIG. 1.

FIG. 3 is a sectional diagram of the night lamp of FIG. 1, showing the traversal of light beams.

FIG. 4 is a perspective break-down diagram showing a night lamp according to a second embodiment of the present invention.

FIG. 5 is a perspective diagram showing the night lamp of FIG. 4 after its assembly.

FIG. 6 is a sectional diagram of the night lamp of FIG. 4, showing the traversal of light beams.

FIG. 7 is a perspective break-down diagram showing a night lamp according to a third embodiment of the present invention.

FIG. 8 is a perspective diagram showing the night lamp of FIG. 7 after its assembly.

FIG. 9 is a perspective diagram showing the night lamp of FIG. 8 from a different angle.

FIG. 10 is a sectional diagram of the night lamp of FIG. 7, showing the traversal of light beams.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

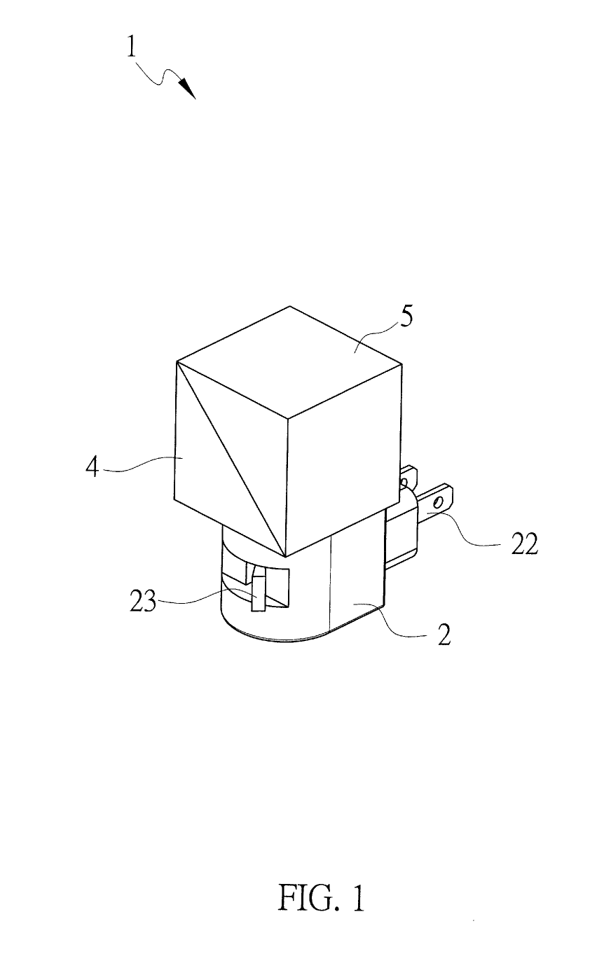

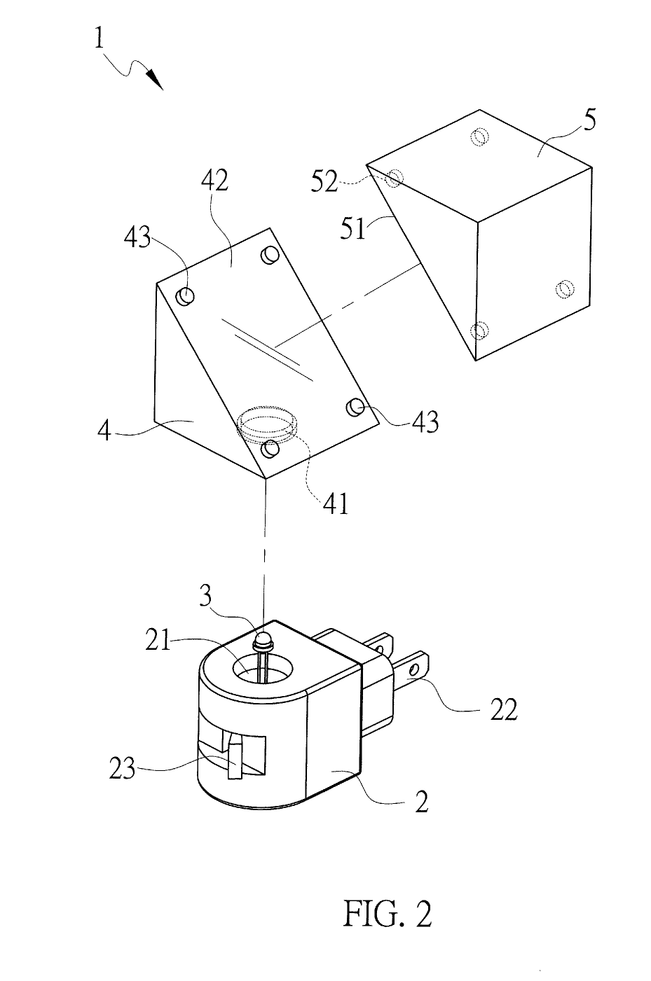

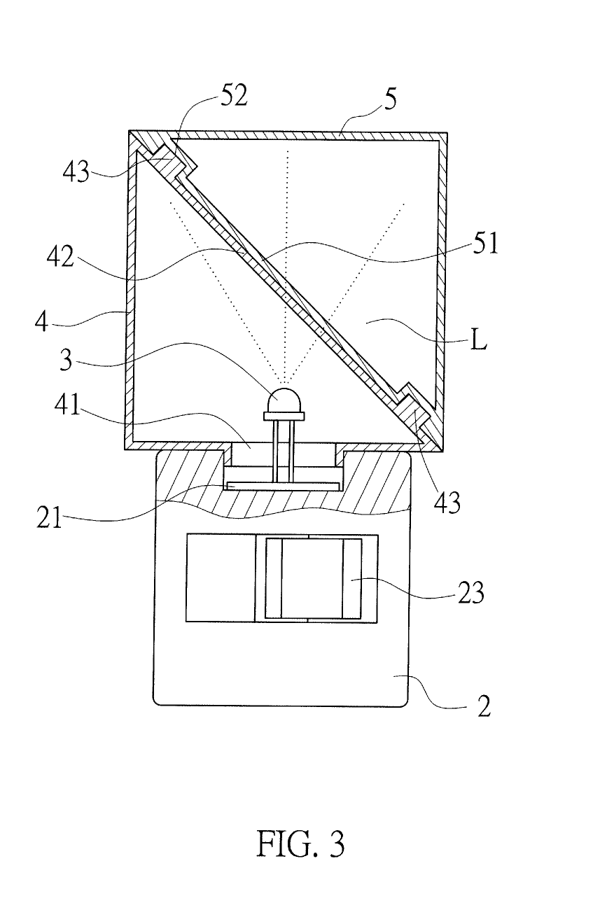

As shown in FIGS. 1 to 3, a night lamp 1 according to a first embodiment of the present invention main contains a lamp base 2, a lighting element 3, a main shade member 4, and an auxiliary shade member 5. The main shade member 4 is configured to a side of the lamp base 2, and the auxiliary shade member 5 is in turn configured to a side of the main shade member 4. In the present embodiment, the main and auxiliary shade members 4 and 5 are of a simple geometric shape, but this shape is only exemplary and is not intended to limit the present invention.

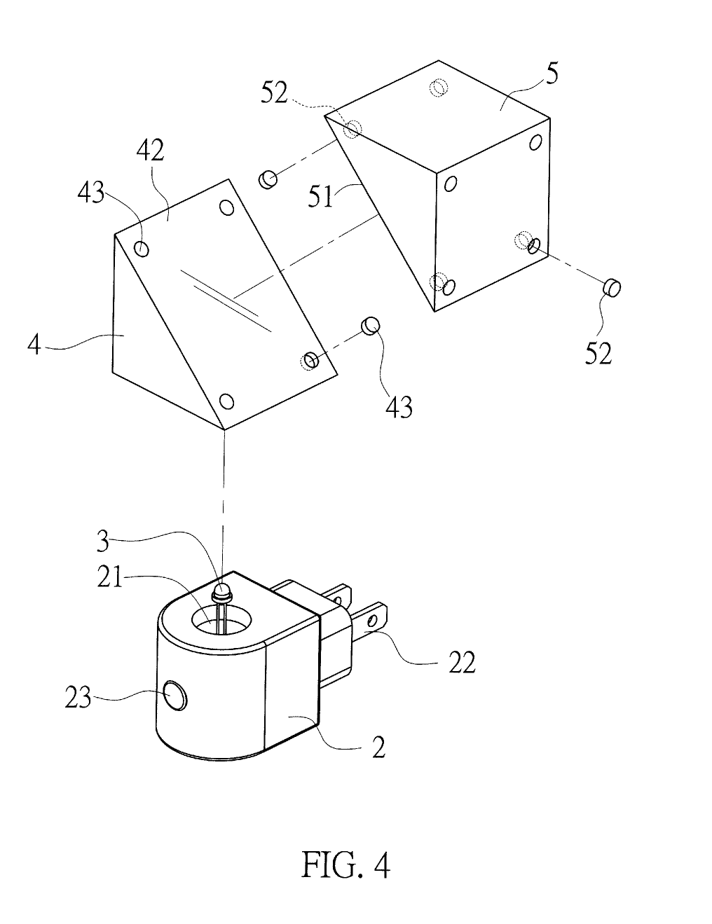

A control circuit 21 is configured inside the lamp base 2. The lighting element 3 can be a light emitting diode (LED) electrically connected to the control circuit 21. The present invention does not impose constraint on the number of lighting element 3 and the present embodiment employs a single lighting element 3 as example. The lighting element 3 is exposed outside the lamp base 2 and prongs 22 for connecting to a power socket are provided from a lateral side of the lamp base 2. The lamp base 2 further contains a switch 23 configured to another lateral side electrically connected to the control circuit 21 and the prongs 22 for turning on and off the control circuit 21 so as to control the illumination of the lighting element 3. The switch 23 can be a manual switch as illustrated, or a light-operated switch as shown in FIG. 4. For the latter, it can be implemented using photoresistor, which should be familiar to people skilled in the related art.

The main shade member 4 is fixedly attached to a top side of the lamp base 2 by adhesive, screw, or embedding where the present invention does not impose specific constraint. The main shade member 4 is hollow and has a light entry element 41 allowing light beams L to enter the inside of the main shade member 4. In the present embodiment, the light entry element 41 is an opening which is not limited by the present invention. Alternatively, the light entry element 41 can be transparent that can equally allow light beams L to enter the inside of the main shade member 4.

The main shade member 4 further contains at least a first light traversal face 42 that is either transparent or semi-transparent so as to allow the light beams L to pass through. The first light traversal face 42 is configured with a first fastening element 43 which contains 4 protrusions, each at a corner of the first light traversal face 42.

The auxiliary shade member 5 is hollow and contains at least a second light traversal face 51 which can be transparent or semi-transparent. The second light traversal face 51 is configured with a second fastening element 52 corresponding to the first fastening element 51 which contains 4 notches. The main and auxiliary shade members 4 and 5 are joined together by matching the first and second fastening elements 43 and 52. The first and second light traversal faces 42 and 51 are thereby attached against each other and light beams L is able to enter the inside of the auxiliary shade member 5 as well. As such, both the main and auxiliary shade members 4 and 5 are illuminated and the present invention provides interesting assembly like building blocks.

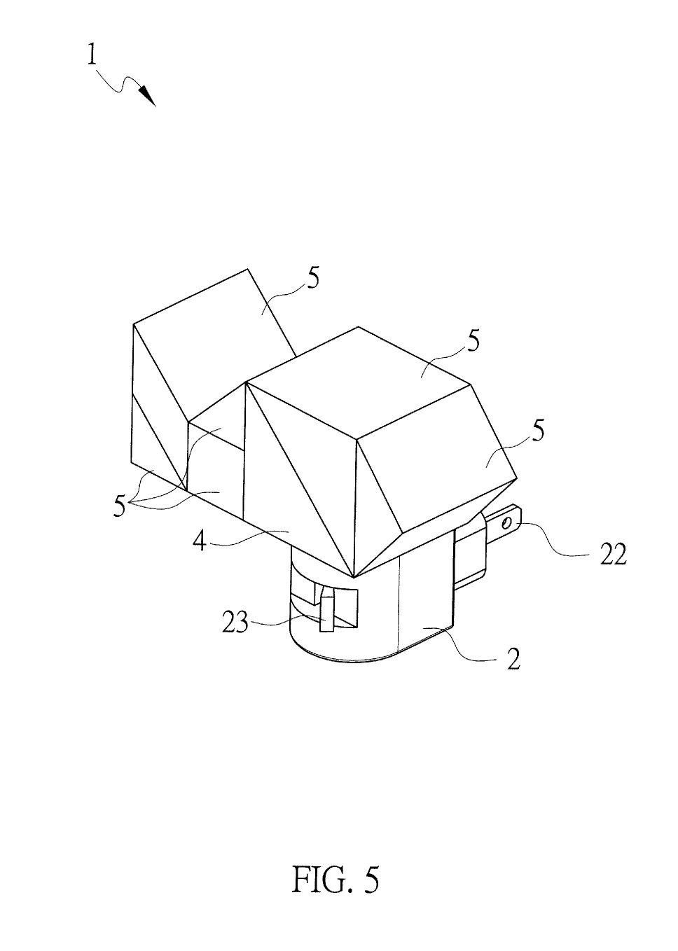

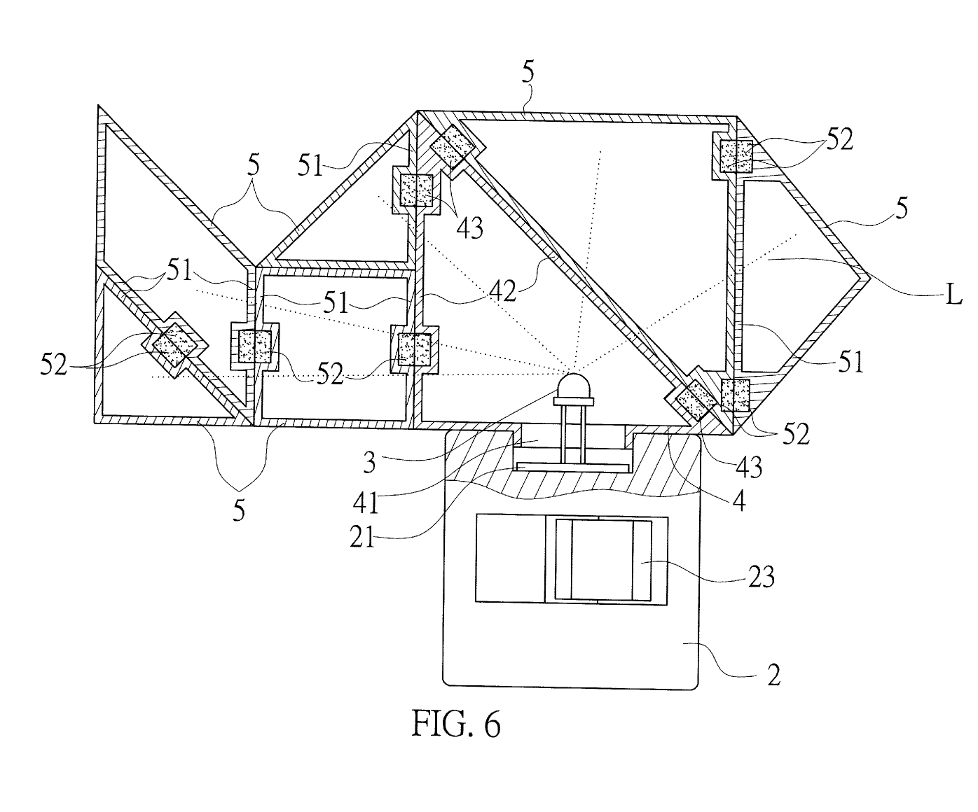

As shown in FIGS. 4 to 6, a second embodiment of the present invention mainly contains a lamp base 2, a lighting element 3, a main shade member 4, and a number of auxiliary shade members 5. The lighting element 3 can be configured inside the lamp base 2 or inside the main shade member 4. The main shade member 4 contains a number of first light traversal faces 42, each configured with a first fastening element 43. The first fastening element 43 contains a number of magnetic pieces arranged at intervals. Each auxiliary shade member 5 contains at least a second light traversal face 51, each configured with a second fastening element 52. The second fastening element 52 contains a number of magnetic pieces arranged at intervals.

As such, the main and auxiliary shade members 4 and 5 can be assembled into various shapes and appearances like building blocks according to user preference. By matching the first and second light traversal faces 42 and 51 between main and auxiliary shade members 4 and 5, and matching the second light traversal faces 51 between auxiliary shade members 5, light beams L from the lighting element 3 can traverse to the insides of various auxiliary shade members 5. In the present embodiment, the magnetic pieces provide attraction by magnetic force through magnets of opposite polarities or through magnets and metals.

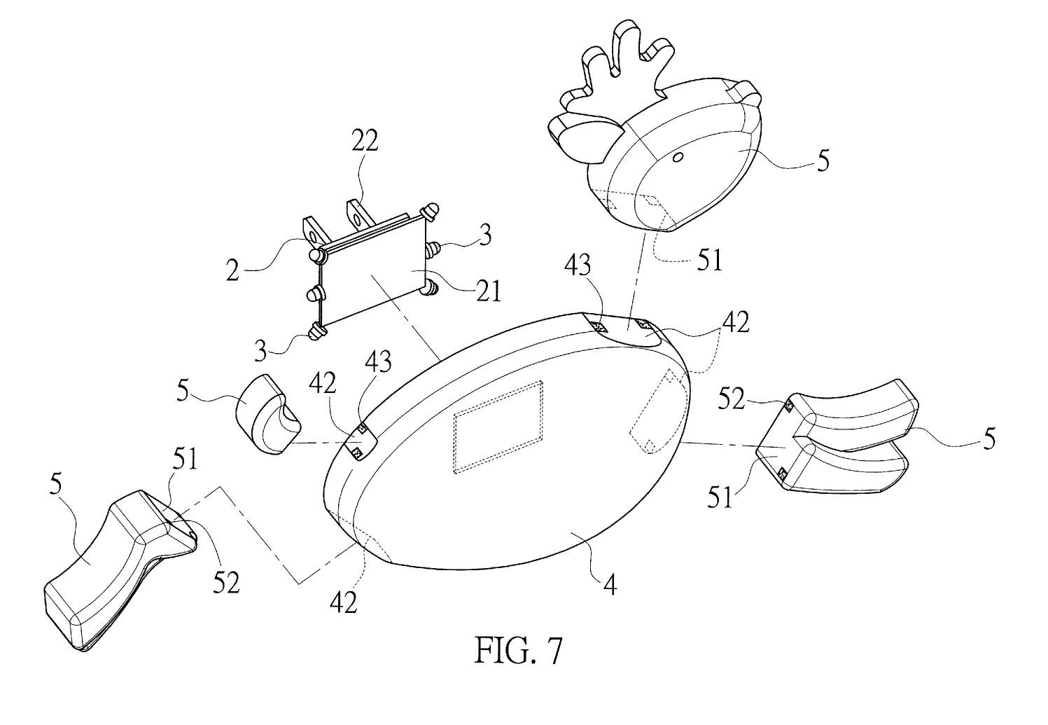

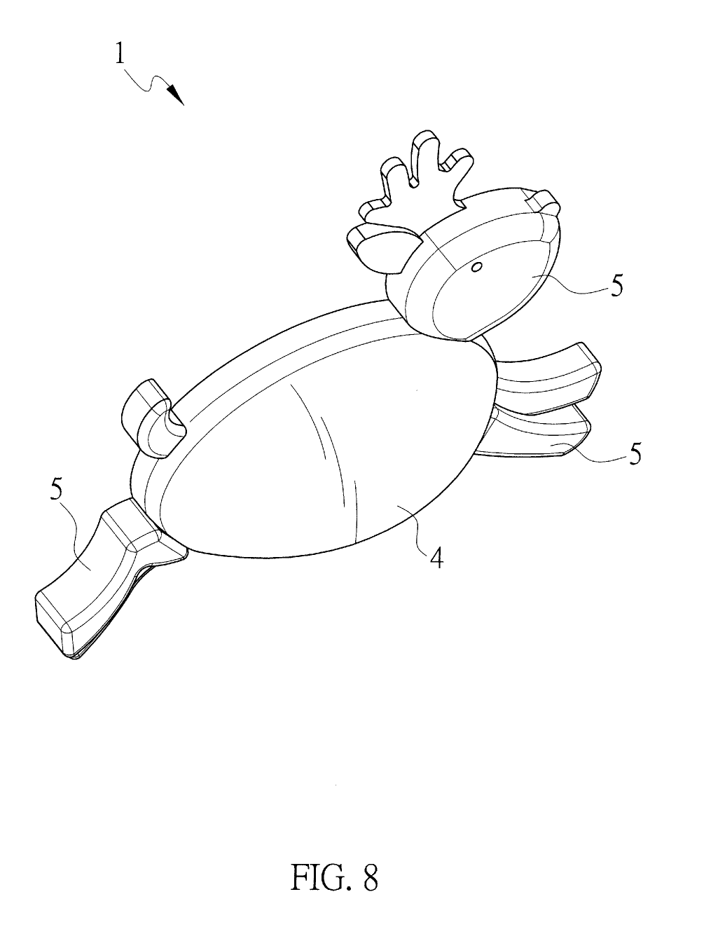

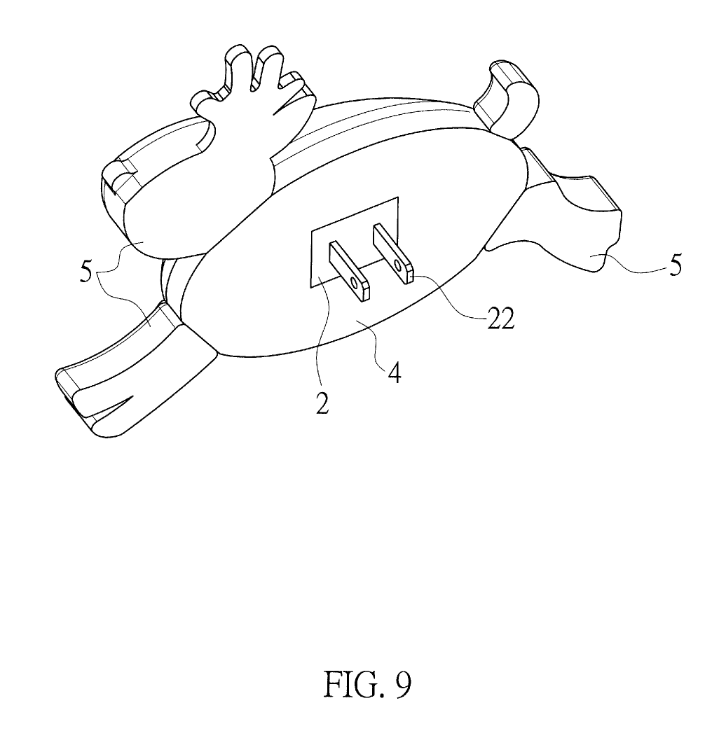

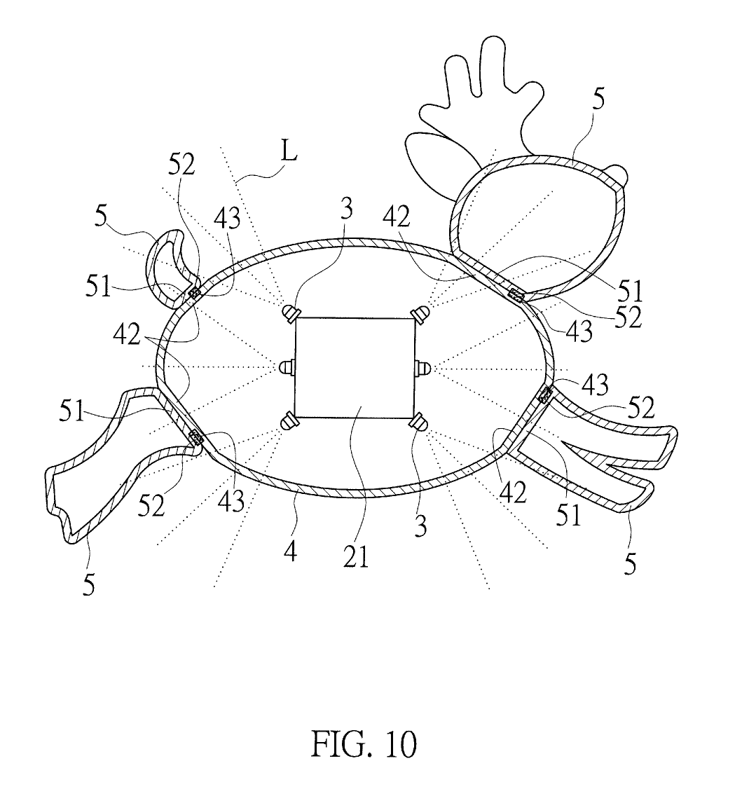

As shown in FIGS. 7 to 10, a third embodiment of the present invention has the main shade member 4 shaped as an animal body with a flat back side. The lamp base 2 is configured to the back side of the main shade member 4. A number of light elements 3 are electrically connected to the control circuit 21. The auxiliary shade members 5 are shaped as animal head and limbs. The main shade member 4 contains a number of first light traversal faces 42, each configured with a first fastening element 43. Each auxiliary shade member 5 contains a second light traversal face 51, each configured with a second fastening element 52. In the present embodiment, the first and second fastening elements 43 and 52 are magnetic pieces. After assembly, the night lamp 1 has a complete animal shape. Therefore the present invention provides the interesting capability like building blocks. Again light beams L from the lighting elements 3 can traverse to the insides of various auxiliary shade members 5, presenting various visual effects.

As described above, the present invention has the following advantages.

First, by a single lighting element, the night lamp of the present invention can have illuminated main and auxiliary shade member, enhancing the night lamp's visual appearance.

Secondly, the main and auxiliary shade members can be assembled into different shapes and appearance, thereby enhancing the night lamp's flexibility.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A night lamp, comprising:
a lamp base comprising a control circuit inside and prongs from a lateral side for connecting to a power source;
at least a lighting element electrically connected to the control circuit;
a main shade member configured to a side of the lamp base and comprising at least a first light traversal face allowing light beams from the lighting element to pass through; and
at least an auxiliary shade member comprising at least a second light traversal face;
wherein the auxiliary shade member is joined to the main shade member by attaching the second light traversal face to the first light traversal face so that light beams from the lighting element is allowed to enter the inside of the auxiliary shade member.

2. The night lamp according to claim 1, wherein each first light traversal face is configured with a first fastening element, and each second light traversal face is configured with a second fastening element for joining to the first fastening element.

3. The night lamp according to claim 2, wherein the first fastening element comprises at least a protrusion; and the second fastening element comprises at least a notch for receiving a protrusion.

4. The night lamp according to claim 2, wherein the first fastening element comprises at least a first magnetic piece; and the second fastening element comprises at least at least a second magnetic piece magnetically attracted to the first magnetic piece.

5. The night lamp according to claim 1, wherein the lighting element is configured inside the lamp base.

6. The night lamp according to claim 1, wherein the lamp base further comprises a switch electrically connected between the control circuit and the prongs.

7. The night lamp according to claim 6, wherein the switch is a light-operated switch.

8. The night lamp according to claim 1, wherein each lighting element is a light emitting diode (LED).
